(19) United States
(12) Patent Application Publication
(10) Pub. No.: US 2011/0158676 A1
(43) Pub. Date: Jun. 30, 2011

(54) IMAGE FORMING APPARATUS

(76) Inventors: Hiroaki NAKAYA, Osaka (JP); Takafumi NAGAI, Osaka (JP)

(21) Appl. No.: 12/955,632

(22) Filed: Nov. 29, 2010

(30) Foreign Application Priority Data
Dec. 24, 2009 (JP) 2009-292578

(51) Int. Cl. G03G 21/20

(52) U.S. Cl. 399/94

(57) ABSTRACT

An image forming apparatus includes a fusing device; a developing device; a partition wall disposed between the fusing device and the developing device, wherein the partition wall includes a Peltier element for transferring heat from the developing device to the fusing device and a cooling heat storage member disposed nearer to the developing device than the Peltier element.

### CROSS-REFERENCE TO RELATED APPLICATION

This application is related to Japanese patent application No. 2009-292578 filed on Dec. 24, 2009 whose priority is claimed under 35 USC §119, the disclosure of which is incorporated by reference in its entirety.

### BACKGROUND OF THE INVENTION

1. Field of the Invention

The present invention relates to an image forming apparatus utilizing an electrophotographic method.

2. Description of the Related Art

Generally, an image forming apparatus that utilizes an electrostatic photography method forms an image by charging, exposing, developing, transferring, cleaning, charge neutralizing, and fusing processes. For example, in the processes of forming an image, an electrostatic latent image is formed as a result of, uniformly charging a surface of a rotating drum type of photoconductor by a charging device, and irradiating the surface of the charged photoconductor with laser light by an exposure device. Next, the electrostatic latent image on the photoconductor is developed by a developing device to form a toner image on the surface of the photoconductor. The toner image on the photoconductor is transferred onto a transfer material by a transfer device, and then, the toner image is fixed onto the transfer material as a result of pressure and heat being applied by a fusing device. The residual toner remaining on the surface of the photoconductor after the transfer is removed by a cleaning device and collected in a collection section of the cleaning device. In addition, the residual charge is removed from the cleaned surface of the photoconductor by a neutralization device in order to prepare the next image formation.

Generally, a mono-component developer including only a toner, or a two-component developer including a toner and a carrier is used as a developer for developing the electrostatic latent image on the photoconductor. Since the carrier is not used in the mono-component developer, it is not necessary to have an agitating mechanism or the like in order to uniformly mix the toner and the carrier. Thus, the mono-component developer has the advantage of allowing the design of the developing device to be simplified. On the other hand, the mono-component developer has the disadvantages that it is difficult to stabilize the toner in electric charge amount. Since the two-component developer needs an agitating mechanism or the like for uniformly mixing the toner and the carrier, the two-component developer has the disadvantage of requiring a complicated design for the developing device. However, as a result of being superior in stabilizing the electric charge amount, the two-component developer is often used in a high-speed image forming apparatus or color image forming apparatus.

In order to meet the demands of color printing, high speed printing, and energy saving, there have been progresses in reducing in particle size and lowering softening in point of the toner used in the two-component developer. However, such a toner has the disadvantage of having a tendency to aggregate due to heat. Thus, if the temperature within the developing device rises due to frictional heat caused during agitation in the developing device, the temperature of the developer increases. This leads to problems that the image is unevenly formed due to the aggregation of the developer and the reduction in fluidity of the developer.

Known methods that solve this problem include a method of suppressing an increase in temperature of the developer in the developing device, by providing a duct between the fusing device and the developing device in order to provide heat insulation therebetween and cool the developer (see, Japanese Unexamined Patent Application No. H11-24352).

However, the method of cooling the developer by sending air has a problem where the cooling capacity decreases when the surrounding temperature of the image forming apparatus is high. Furthermore, when the supply of power to the image forming apparatus is terminated immediately after image formation, since the fan for sending cooling air also stops, the heat generated from the fusing device is trapped in the image forming apparatus and increases the temperature within the developing device, leading to problems such as aggregation of the developer and reduction in fluidity of the developer.

### SUMMARY OF THE INVENTION

The present invention has been made in view of such situations, and provides an image forming apparatus in which aggregation of the developer and reduction in fluidity of the developer are unlikely to happen, even when the surrounding temperature of the image forming apparatus is high, or when the supply of power is terminated immediately after image formation.

The present invention provides an image forming apparatus comprising: a fusing device; a developing device; a partition wall disposed between the fusing device and the developing device, wherein the partition wall includes a Peltier element for transferring heat from the developing device to the fusing device and a cooling heat storage member disposed nearer to the developing device than the Peltier element.

The present invention can prevent non-uniform image density due to aggregation of the developer and reduction in fluidity of the developer, resulting from overheating of the developer. The present invention can also suppress radiational cooling of the fusing device and can shorten a heating time required for the fusing device when resuming image formation. Such advantages are achieved by using the Peltier element. The partition wall blocks conduction of heat from the fusing device to the developing device. The Peltier element transfers heat from the developing device to the fusing device through the partition wall. As a result, cooling of the developing device, and applying and retaining heat to the fusing device are efficiently conducted.

### BRIEF DESCRIPTION OF THE DRAWINGS

FIG. 1 is an illustrative diagram showing the whole configuration of an image forming apparatus in which a developing device according to an embodiment of the present invention is used.

FIG. 2 is a cross sectional view, showing an outlined configuration of a toner-supplying device of the image forming apparatus in FIG. 1.

FIG. 3 is a cross sectional view as viewed from line C-C of FIG. 2.

FIG. 4 is a cross sectional view, showing an outlined configuration of the developing device of the image forming apparatus shown in FIG. 1.

FIG. 5 is a cross sectional view as viewed from line A-A of FIG. 4.

FIG. 6 is cross sectional view as viewed from line B-B of FIG. 4.

FIG. 7 is a front view of an outlined configuration of a partition wall in FIG. 1.

FIG. 8 is a front view of the partition wall in an alternate example.

### DESCRIPTION OF THE PREFERRED EMBODIMENTS

An image forming apparatus of the present invention comprises: a fusing device; a developing device; a partition wall disposed between the fusing device and the developing device, wherein the partition wall includes a Peltier element which transfers heat from the developing device to the fusing device.

Here, a Peltier element refers to a plate-like semiconductor device that utilizes the Peltier effect. By utilizing the Peltier effect, heat can be transferred from one metal to the other metal when current is passed through a joined part of the two types of metal. Thus the Peltier element can be used as a heat pump which transfers heat from a low temperature side to a high temperature side of the element.

The partition wall may include a cooling heat storage member, and the cooling heat storage member may be disposed on the developing device side of the Peltier element.

The partition wall may include a warming heat storage member, and the warming heat storage member may be disposed on the fusing device side of the Peltier element.

A first and a second temperature sensors which respectively detect temperatures of the cooling heat storage member and the warming heat storage member may be further included, and the Peltier element may be controlled based on the temperatures detected by the first and the second temperature sensors.

The Peltier element is preferably interposed between the cooling heat storage member and the warming heat storage member.

The Peltier element is preferably controlled so as to heat the warming heat storage member and cool the cooling heat storage member.

A heat insulator interposed between the cooling heat storage member and the warming heat storage member may be further included.

The cooling heat storage member preferably includes a low melting point material having a melting point of 35° C. or higher but 45° C. or lower.

The warming heat storage member preferably includes a low melting point material having a melting point of 60° C. or higher but 100° C. or lower.

Each low melting point material may be contained in a container made of a copper plate or an aluminum plate.

The container preferably has a structure in which a volume thereof is variable.

The present invention will be described in detail in the following by using an embodiment shown in the drawings.

### [Image Forming Apparatus]

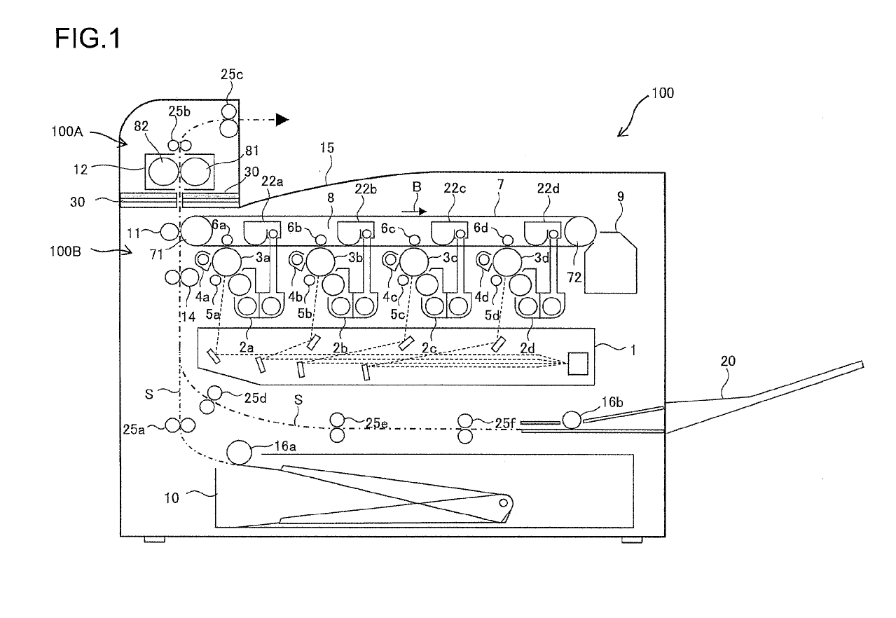

FIG. 1 is an illustrative diagram showing the whole configuration of the image forming apparatus according to an embodiment of the present invention.

An image forming apparatus 100 forms a multicolored or monochromatic image on a predefined sheet (recording paper, recording medium) in accordance with image data transmitted from an external source. A scanner or the like may be included in the upper portion of the image forming apparatus 100.

The image forming apparatus 100 includes: a fusing device housing part 100A in which a fusing device 12 is housed; a developing device housing part 100B in which developing devices 2a, 2b, 2c, and 2d (hereinafter, referred to as a developing device 2) are housed; and a partition wall 30 disposed therebetween.

### [Partition Wall]

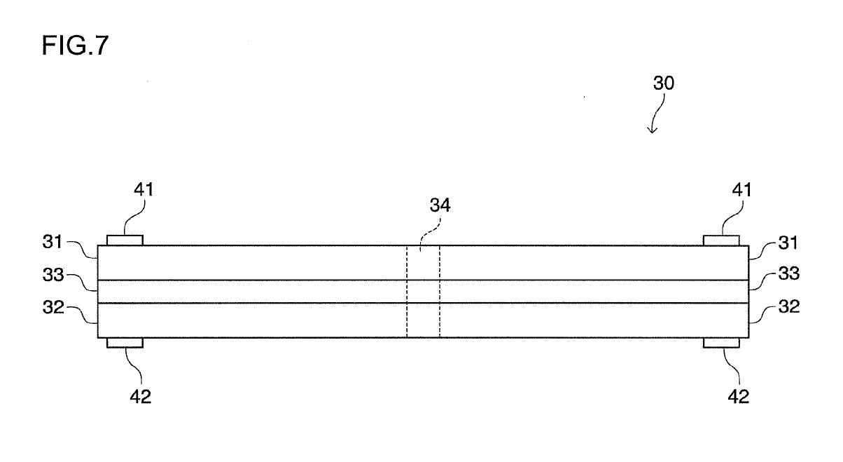

FIG. 7 is a front view of an outlined configuration of the partition wall 30 in FIG. 1. The partition wall 30 is a plate-like sandwich structure member including: a Peltier element 33; a warming heat storage member 31 disposed on a fusing device housing part 100A side of the Peltier element 33; and a cooling heat storage member 32 disposed on a developing device housing part 100B side of the Peltier element 33. The partition wall 30 blocks conduction of heat from the fusing device 12 to the developing device 2.

The Peltier element 33 is connected to a power supply (not shown) by electrical wiring, and current is passed through the Peltier element 33 in a direction that allows the Peltier element 33 to heat the warming heat storage member 31 and to cool the cooling heat storage member 32. As a result of heat being transferred from the developing device 2 side to the fusing device 12 side by the Peltier element 33, applying and retaining heat to the fusing device 12, and cooling and reserving coldness for the developing device 2 can be conducted efficiently.

Two warming heat storage member temperature sensors 41 are disposed on a surface of the warming heat storage member 31 to detect the temperature of the warming heat storage member 31. Furthermore, two cooling heat storage member temperature sensors 42 are disposed on a surface of the cooling heat storage member 32 to detect the temperature of the cooling heat storage member 32. Excessive heating and cooling can be prevented by monitoring the temperatures of the warming heat storage member 31 and the cooling heat storage member 32, and by controlling an amount of current supplied to the Peltier element 33.

The warming heat storage member 31 is a hollow thin box-shaped heat container which contains a low melting point material having a melting point of 60° C. or higher but 100° C. or lower; and the container is made of a copper plate, an aluminum plate, a copper alloy plate or an aluminum alloy plate. The cooling heat storage member 32 is a hollow thin box-shaped container which contains a low melting point material having a melting point of 35° C. or higher but 45° C. or lower; and the container is made of a copper plate or an aluminum plate, a copper alloy plate or an aluminum alloy plate. Each of the containers has a structure in which a volume thereof is variable, i.e., a flexible structure which is expandable (or contractible) toward the opposite side (outwards) of the Peltier element 33, and the structure can absorb an internal pressure caused when the low melting point material expands (or contracts).

The container having the flexible structure may be formed, for example, as an accordion-like structure by using an aluminum plate having a thickness of 0.5 mm to 1 mm.

A slit 34 is formed on the partition wall 30 in order to allow a sheet to pass through the partition wall 30 from the developing device housing part 100B to the fusing device housing part 100A.

The warming heat storage member 31, which is heated by the Peltier element 33, is preferably controlled at a temperature higher than the melting point of the low melting point material, such that the contained low melting point material (melting point of 60° C. or higher but 100° C. or lower) is in a melted state (i.e., a state in which solidification energy is stored therein). However, since energy loss becomes significant if the control temperature is too high, the control temperature is preferably about 1° C. to 10° C. higher than the melting point.

The cooling heat storage member 32, which is cooled by the Peltier element 33, is preferably controlled at a temperature lower than the melting point of the low melting point material, such that the contained low melting point material (melting point of 35° C. or higher but 45° C. or lower) is in a solidified state (i.e., a state that can absorb melting energy). However, since energy loss becomes significant if the control temperature is too low, the control temperature is preferably about 1° C. to 10° C. lower than the melting point.

Publicly known organic materials and inorganic materials can be used as the low melting point material which has a melting point of 35° C. or higher but 45° C. or lower and which is contained in the cooling heat storage member 32.

More specifically, the inorganic materials include: calcium chloride hexahydrate (melting point 30° C.), lithium nitrate trihydrate (melting point 30° C.), sodium sulfate decahydrate (melting point 32° C.), sodium carbonate decahydrate (melting point 33° C.), disodium hydrogen phosphate dodecahydrate (melting point 36° C.) and hexafluorophosphate (melting point 44° C.).

The Organic Materials Include:

ester compounds such as methyl palmitate (melting point 30° C.), methyl margarate (melting point 30° C.), amyl stearate (melting point 30° C.), diethyl 1,13-tridecanedicarboxylate (melting point 30° C.), propyl stearate (melting point 31° C.), tetradecyl myristate (melting point 32° C.), octyl stearate (melting point 32° C.), tetradecyl laurate (melting point 33° C.), dodecyl myristate (melting point 35° C.), octadecyl laurate (melting point 37° C.), methyl stearate (melting point 38° C.), tetradecyl myristate (melting point 39° C.), dodecyl palmitate (melting point 41° C.) and methyl arachidate (melting point 45° C.);

alcohols such as α-terpineol (melting point 36° C.), 1-tetradecanol (melting point 38° C.) and myristyl alcohol (melting point 38° C.);

phenol compounds such as phenol (melting point 41° C.); aliphatic compounds such as n-nonadecane (melting point 32° C.), n-eicosane (melting point 37° C.) and docosane (melting point 44° C.);

nitrogen-containing aromatic compounds such as N-octyl-4-methylpyridinium (melting point 44° C.) and N-hexylpyridinium (melting point 45° C.);

siloxane compounds such as stearyl methylpolysiloxane (melting point 32° C.); and the like.

In particular, in terms of less dermal irritancy and environmental safety, higher alcoholates such as 1-tetradecanol (melting point 38° C.) and myristyl alcohol (melting point 38° C.), and ester compounds such as dodecyl palmitate (melting point 41° C.) and methyl arachidate (melting point 45° C.) are preferable.

Publicly known organic materials and inorganic materials can be used as the low melting point material which has a melting point of 60° C. or higher but 100° C. or lower and which is contained in the warming heat storage member 31.

More specifically, the organic materials include:

alcohols such as octadecanol (melting point 60° C.), eicosanol (melting point 60° C.), docosanol (melting point 67° C.) and stearyl alcohol (melting point 61° C.),

fatty acids such as palmitic acid (melting point 63° C.), stearic acid (melting point 70° C.), eicosanoic acid (melting point 75° C.) and triacontanoic acid (melting point 95° C.),

ester compounds such as dicyclohexyl phthalate (melting point 65° C.), glycerol stearate (melting point 65° C.), ethylene glycol dibenzoate (melting point 70° C.), trimethylolethane tribenzoate (melting point 73° C.), pentaerythritol tetrabenzoate (melting point 95° C.), sucrose octaacetate (melting point 89° C.), catechol dibenzoate (melting point 86° C.), diphenyl phthalate (melting point 73° C.) and sucrose benzoate (melting point 98° C.),

hydroxy-fatty acids such as 1, 2-hydroxystearic acid (melting point 73° C.),

fatty amids such as oleamide (melting point 75° C.) and stearamide (melting point 100° C.), and ketone compounds such as diheptadecyl ketone (melting point 80° C.).

The Inorganic Materials Include:

Rose's alloy (melting point 100° C.), Newton's alloy (melting point 95° C.), Wood's alloy (melting point 65° C.), Lipowitz's alloy (melting point 72° C.) and zinc nitrate heptahydrate (melting point 100° C.).

Above all, the inorganic materials such as Roes's alloy, Newton's alloy, Wood's alloy and Lipowitz's alloy are preferable since they have lower boiling points.

Furthermore, specific commercially available products that can be used include: ethylene vinyl acetate copolymer ULTRACEN 681 (melting point 70° C.) manufactured by Tosoh Corp.; paraffin wax HNP9 (melting point 70° C.) manufactured by Nippon Seiro Co., Ltd.; paraffin wax HNP10 (melting point 75° C.) manufactured by Nippon Seiro Co., Ltd.; paraffin wax HNP190 (melting point 80° C.) manufactured by Nippon Seiro Co., Ltd.; carnauba wax (melting point 85° C.) manufactured by S. Kato & Co.; and the like.

### [Fusing Device Housing Part]

As shown in FIG. 1, the fusing device housing part 100A houses: the fusing device 12; and a conveying roller 25b and a paper outputting roller 25c for discharging a fused sheet onto a paper output tray 15.

The fusing device 12 includes a heating roller 81, a pressure roller 82. The heating roller 81 and the pressure roller 82 pinch the sheet and rotate. The heating roller 81 is controlled by a control section (not shown) so as to be at a predefined fusing temperature. The control section controls the temperature of the heating roller 81 based on a detection signal from a temperature detector (not shown).

Together with the pressure roller 82, the heating roller 81 conducts a thermo compression bonding on the sheet to melt and apply pressure on the toner image which has been transferred to the sheet. As a result, the toner image is fused onto the sheet. The sheet that is fused with the toner image (toner image having each of the colors) is outputted onto the paper output tray 15 in a turned-over state (a state where the toner image is facing downward) by the conveying roller 25b and the paper outputting roller 25c.

### [Developing Device Housing Part]

As shown in FIG. 1, the developing device housing part 100B houses: photoconductor drums 3a, 3b, 3c, and 3d (hereinafter, referred to as a photoconductor drum 3) having surfaces where electrostatic latent images are formed; chargers 5a, 5b, 5c, and 5d (hereinafter, referred to as a charger 5) which charge the surfaces of the photoconductor drum 3; an exposure unit 1 that forms the electrostatic latent images on the surfaces of the photoconductor drum 3; the developing device 2 which supplies toners to the electrostatic latent images on the surfaces of the photoconductor drum 3 and which forms toner images; toner-supplying devices 22a, 22b, 22c, and 22d (hereinafter, referred to as a toner-supplying device 22) which supply the toners to the developing device 2; and an intermediate transfer belt unit 8 which transfers the toner images from the surfaces of the photoconductor drum 3 to a recording medium. With regard to the characters of a to d described above, a represents members for black image formation, b represents members for cyan image formation, c represents members for magenta image formation, and d represents members for yellow image formation.

Based on image data inputted to the image forming apparatus 100 for every color components of black (K), cyan (C), magenta (M), and yellow (Y); a black toner image, a cyan toner image, a magenta toner image, and a yellow toner image are respectively formed on the four surfaces of the photoconductor drum 3. All the formed toner images are overlaid onto the intermediate transfer belt unit 8 to form a color image.

Furthermore, the image forming apparatus 100 includes a paper feed tray 10, a sheet-conveying path S, and the paper output tray 15.

The photoconductor drum 3 is a cylindrical member that conducts latent image formation through charging and exposure, and exhibits conductivity upon being irradiated with light to form an electrical image called an electrostatic latent image on the surfaces of the photoconductor drum 3.

The photoconductor drum 3 is supported by a driving means (not shown) in a manner that allows the photoconductor drum 3 to be rotationally driven around a shaft line. The photoconductor drum 3 includes a conductive substrate (not shown) and a photosensitive layer formed on the surface of the conductive substrate.

The charger 5 uniformly charges the surfaces of the photoconductor drum 3 with a predefined electric potential. Other than a contact roller type charger shown in FIG. 1, a contact brush type charger, a non-contact charger type charger, or the like may be used as the charger 5.

The exposure unit 1 is an exposure device which irradiates light between the charging device 5 and the developing device 2 toward the surfaces of the photoconductor drum 3 in accordance with the image data. A laser scanning unit (LSU) including a laser irradiating section and a reflective mirror is used as the exposure unit 1 in the present embodiment; however, other than the laser scanning unit, an EL (Electroluminescence) having light emitting elements arranged in an array, or an LED write head may be used as the exposure unit 1.

By exposing the charged photoconductor drum 3 in accordance with inputted image data, the exposure unit 1 forms the electrostatic latent images on the surfaces of the photoconductor drum 3 in accordance with the image data.

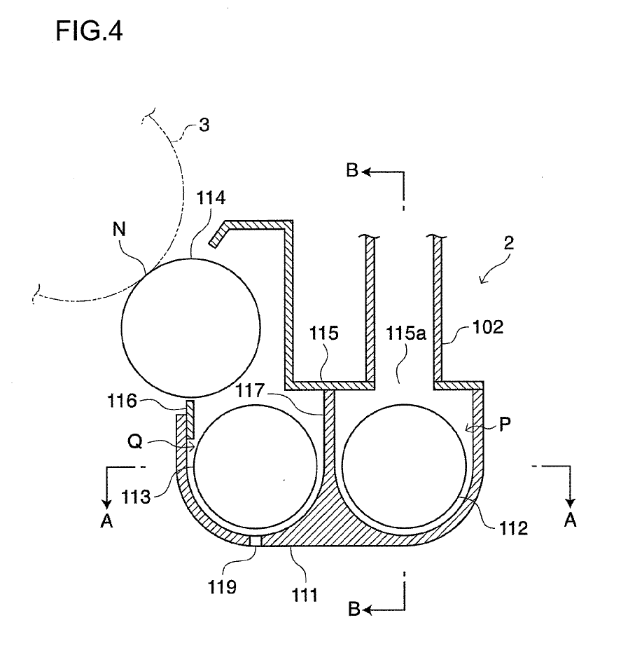

The developing device 2 brings out (develops) the electrostatic latent images formed on the photoconductor drum 3 by using either one of the toners of K, C, M, or Y. The developing device 2 includes, on an upper portion thereof, a toner-conveying pipe 102 (FIG. 4) which receives a toner from the toner-supplying device 22. The details will be described below.

The toner-supplying device 22 is disposed at an elevation higher than that of a developing tank 111 (FIG. 4), and stores a new toner (powdery toner). The toner is supplied from the toner-supplying device 22 to the developing tank 111 via the toner-conveying pipe 102. The details will be described below.

Cleaner units 4a, 4b, 4c, and 4d (hereinafter, referred to as a cleaner unit 4) remove and collect the toner remaining on the surfaces of the photoconductor drum 3 after development and after an image transfer process.

The intermediate transfer belt unit 8 is disposed at an elevation higher than that of the photoconductor drum 3. The intermediate transfer belt unit 8 includes: intermediate transfer rollers 6a, 6b, 6c, and 6d (hereinafter, referred to as an intermediate transfer roller 6); an intermediate transfer belt 7; an intermediate transfer belt driving roller 71; an intermediate transfer belt driven roller 72; an intermediate transfer belt tension mechanism which is not shown; and an intermediate transfer belt cleaning unit 9.

The intermediate transfer roller 6, the intermediate transfer belt driving roller 71, the intermediate transfer belt driven roller 72, and the intermediate transfer belt tension mechanism extend the intermediate transfer belt 7, and allow the intermediate transfer belt 7 to be rotationally driven in an arrow B direction of FIG. 1.

The intermediate transfer roller 6 is rotatably supported at intermediate transfer roller attaching parts of the intermediate transfer belt tension mechanism in the intermediate transfer belt unit 8. A transfer bias is applied on the intermediate transfer roller 6 in order to transfer toner images from the photoconductor drum 3 onto the intermediate transfer belt 7.

The intermediate transfer belt 7 is installed so as to make contact with the photoconductor drum 3. A color toner image (multicolored toner image) is formed on the intermediate transfer belt 7 by sequentially transferring and overlaying the toner images which are formed the photoconductor drum 3 and which include each of the color components. The intermediate transfer belt 7 is formed, for example, by using a film having a thickness of about 100 μm to 150 μm in an endless form.

The transfer of the toner images from the photoconductor drum 3 to the intermediate transfer belt 7 is conducted by the intermediate transfer roller 6 contacting the back side of the intermediate transfer belt 7. A high voltage transfer bias (a high voltage having a reverse polarity (+) of a charge polarity (−) of the toner) is applied on the intermediate transfer roller 6 in order to transfer the toner images.

The intermediate transfer roller 6 is formed by using a metal (e.g., stainless steel) shaft having a diameter of, for example, 8 to 10 mm as a base, and the surface is covered with an elastic material having conductivity (e.g., EPDM, urethane foam, and the like). The conductive elastic material allows the intermediate transfer roller 6 to uniformly apply a high voltage on the intermediate transfer belt 7. Although a transfer electrode having a roller shape (the intermediate transfer roller 6) is used in the present embodiment, it is possible to use those having other shapes such as a brush and the like.

As described above, electrostatic latent images on the photoconductor drum 3 are respectively brought out to be toner images by the toner in accordance with respective color components. The toner images are layered as a result of being overlaid on the intermediate transfer belt 7. A toner image layered as such moves, by a rotation of the intermediate transfer belt 7, to a contact position (transfer part) between the intermediate transfer belt 7 and a paper that has been conveyed, and is transferred onto the paper by a transfer roller 11 disposed at this position. Here, while the intermediate transfer belt 7 and the transfer roller 11 are being pressed against each other at a predefined nip, a voltage is applied to the transfer roller 11 in order to transfer the toner image to the paper. This voltage is a high voltage having a reverse polarity (+) of a charge polarity (−) of the toner.

In order to steadily obtain the nip, either one of the transfer roller 11 or the intermediate transfer belt driving roller 71 is formed from a hard material such as a metal and the like, and the other is formed from a flexible material such as the case with an elastic roller (elastic rubber roller, formable resin roller, or the like) and the like.

Causes that generate color mixing of toners in the next process include: toners adhered to the intermediate transfer belt 7 due to the contact between the intermediate transfer belt 7 and the photoconductor drum 3; and toners which have not been transferred upon transfer of the toner image from the intermediate transfer belt 7 to the paper and which are remaining on the intermediate transfer belt 7. Such toners are removed and collected by the intermediate transfer belt cleaning unit 9 in order to prevent color mixing of toners.

The intermediate transfer belt cleaning unit 9 includes a cleaning blade (cleaning member) that makes contact with the intermediate transfer belt 7. A part where the intermediate transfer belt 7 is making contact with the cleaning blade is supported from the back side by the intermediate transfer belt driven roller 72.

The paper feed tray 10 is for storing sheets (e.g., recording paper) used for image formation, and is installed below an image forming section and the exposure unit 1. On the other hand, the paper output tray 15 installed at an upper section of the image forming apparatus 100 is for placing and holding printed sheets in a facedown manner.

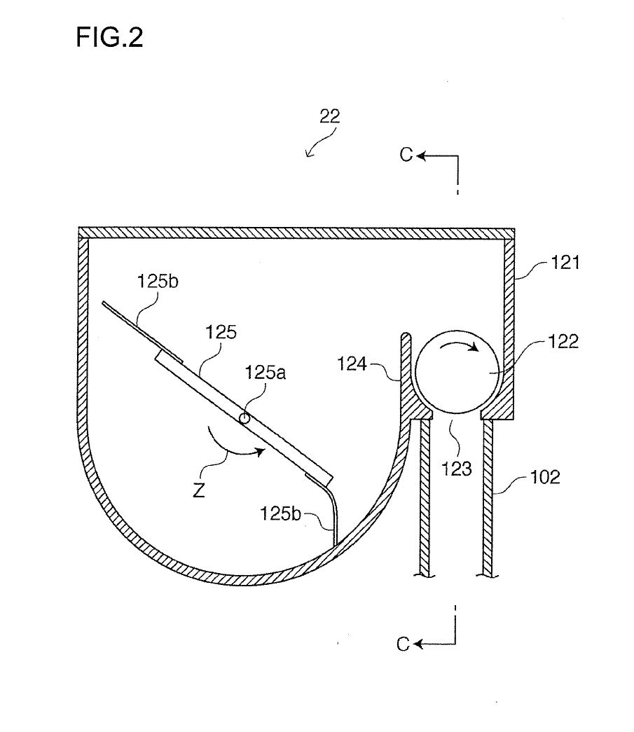

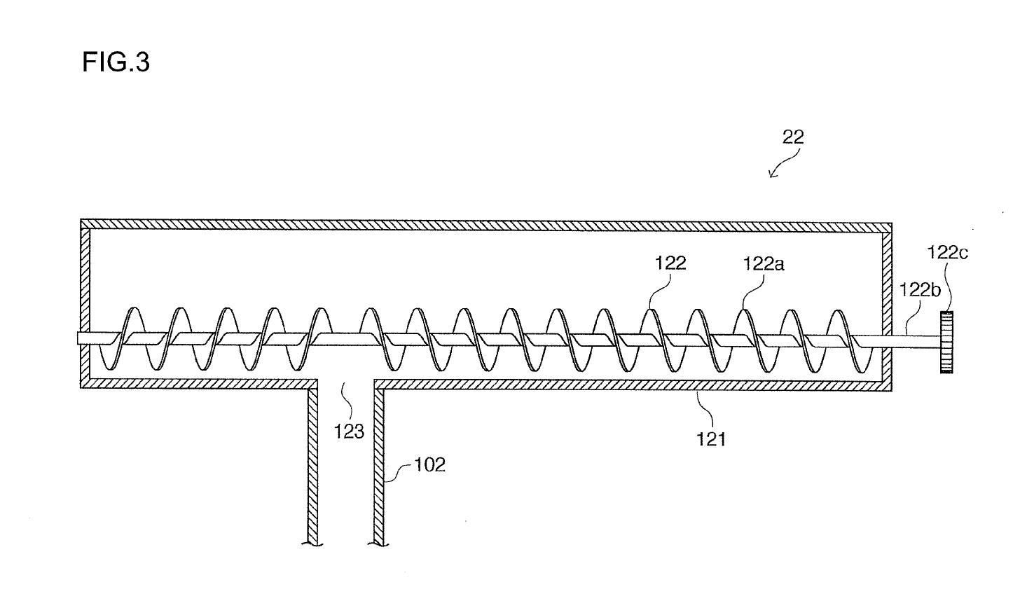

FIG. 2 is a cross sectional view, showing an outlined configuration of the toner-supplying device; and FIG. 3 is a cross sectional view as viewed from line C-C of FIG. 2.

As shown in FIG. 2, the toner-supplying device 22 includes a toner container 121, a toner-agitating member 125, a toner-discharging member 122, and a toner outlet 123. The toner-supplying device 22 is disposed on the upper side of the developing tank 111 (FIG. 4), and stores a new toner (powdery toner). Due to a rotation of toner-discharging member (discharge screw) 122, the toner in the toner-supplying device 22 is supplied to the developing tank 111 (FIG. 4) via the toner outlet 123 and the toner-conveying pipe 102.

The toner container 121, which contains the toner, is a nearly semicircle tube shaped containment member having an interior space, and rotatably supports the toner-agitating member 125 and the toner-discharging member 122. The toner outlet 123 is an approximately rectangle opening portion disposed below the toner-discharging member 122 but proximal to a center part of the toner-discharging member 122 in a shaft direction, and is disposed at a position adjacent to the toner-conveying pipe 102.

The toner-agitating member 125 is a plate-like member that, as a result of rotating with a rotational shaft 125a being a center of rotation, pumps up and conveys the toner in the toner container 121 to the toner-discharging member 122 while agitating the toner contained in the toner container 121. A toner-pumping member 125b is disposed at a front end of the toner-agitating member 125. The toner-pumping member 125b is a flexible polyethylene terephthalate (PET) sheet, and is attached on both ends of the toner-agitating member 125.

The toner-discharging member 122 supplies the toner in the toner container 121 to the developing tank 111 (FIG. 4) through the toner outlet 123, and includes: an auger screw including a toner-conveying blade 122a and a toner-discharging member rotational shaft 122b; and a toner-discharging member rotation gear 122c, as shown in FIG. 3. The toner-discharging member 122 is rotationally driven by a toner-discharging member driving motor which is not shown. The direction of the auger screw is configured such that the toner is conveyed toward the toner outlet 123 from both ends of the toner-discharging member 122 in the shaft direction.

A toner-discharging member partition wall 124 is interposed between the toner-discharging member 122 and the toner-agitating member 125. As a result, an appropriate quantity of the toner pumped up by the toner-agitating member 125 can be held in the periphery of the toner-discharging member 122.

As shown in FIG. 2, the toner-agitating member 125 agitates the toner by rotating in the arrow Z direction, and pumps up the toner toward the toner-discharging member 122. At this moment, since being flexible, the toner-pumping member 125b deforms and slides along the inner wall of the toner container 121 during the rotation, and supplies the toner toward the toner-discharging member 122 side. Next, the supplied toner is led toward the toner outlet 123 due to the rotation of the toner-discharging member 122.

### Developing Device

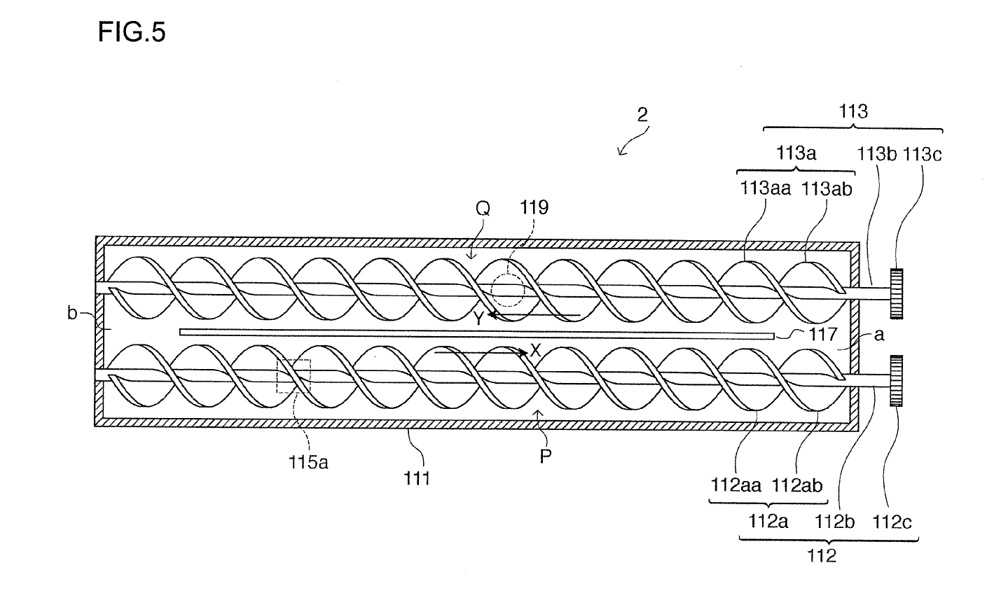

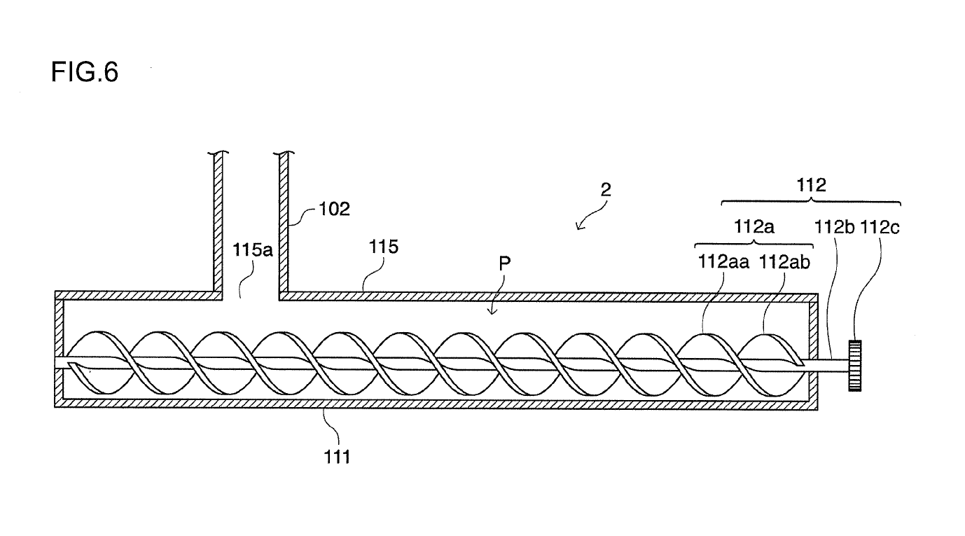

FIG. 4 is a cross sectional view, showing a configuration of the developing device; FIG. 5 is a cross sectional view as viewed from line A-A of FIG. 4; and FIG. 6 is a cross sectional view as viewed from line B-B of FIG. 4.

As shown in FIG. 4, the developing device 2 includes a developing roller 114 disposed in the developing tank 111 so as to face the photoconductor drum 3. The developing device 2 is a device which supplies the toners to the surfaces of the photoconductor drum 3 by means of the developing roller 114, and which brings out (develops) the electrostatic latent images formed on the surfaces of the photoconductor drum 3.

Besides the developing roller 114, the developing device 2 includes: the developing tank 111; a developing tank covering 115; a toner supply opening 115a; a doctor blade 116; a first agitating-conveying member 112; a second agitating-conveying member 113; a partition plate (partition wall) 117; and a toner concentration detection sensor (magnetic permeability sensor) 119.

The developing tank 111 is a tank that contains a two-component developer (hereinafter, simply referred to as a “developer”) containing the toner and a carrier. In addition, the developing tank 111 includes the developing roller 114, the first agitating-conveying member 112, the second agitating-conveying member 113, and the like. The carrier in the present embodiment is a magnetic carrier which has a magnetic property.

The developing roller 114 is a magnet roller that is rotationally driven around a center shaft by a driving means which is not shown. The developing roller 114 pumps up the developer in the developing tank 111, holds the developer on its surface, and supplies the photoconductor drum 3 with the toner included in the developer held on the surface.

Furthermore, the developing roller 114 is installed so as to face the photoconductor drum 3, but to be separated from the photoconductor drum 3 by having a gap therebetween. The developer conveyed by the developing roller 114 makes contact with the photoconductor drum 3 at the most proximal part. This contact area is a development nip part N. At the development nip part N, a development bias voltage is applied on the developing roller 114 by a power supply (not shown) connected to the developing roller 114, and the toner is supplied to the electrostatic latent images on the surfaces of the photoconductor drum 3 from the developer on the surfaces of the developing roller 114.

The doctor blade 116 is disposed in proximity of the surfaces of the developing roller 114. The doctor blade 116 is a rectangular plate-like member that extends parallel to the developing roller 114 in the shaft direction. One end of the doctor blade 116 in the short side direction is supported by the developing tank 111, and the doctor blade 116 is installed such that a front end of the doctor blade 116 and the surfaces of the developing roller 114 are separated by having a gap therebetween. Although stainless steel can be used as the material for the doctor blade 116, aluminum, a synthetic resin, and the like can also be used.

As shown in FIG. 5, the first agitating-conveying member 112 includes: a helical auger screw including a helical first conveying blade (helical blade) 112a and a first rotational shaft 112b; and a first conveying gear 112c. The first agitating-conveying member 112 agitates and conveys the developer, by being rotationally driven by a driving means (not shown) such as a motor.

The first conveying blade 112a is a double helix blade having a double helix structure, and includes a first(A) helical blade 112aa and a first(B) helical blade 112ab.

The first(A) helical blade 112aa and the first(B) helical blade 112ab have identical helical pitches. In addition, a phase difference between the first(A) helical blade 112aa and the first(B) helical blade 112ab is 180 degrees. Assumed next is a case where the first agitating-conveying member 112 is viewed in the shaft direction of the first rotational shaft 112b from the upstream of the developer conveyance direction. If the first(A) helical blade 112aa alone is to be rotated clockwise, the first(A) helical blade 112aa and the first(B) helical blade 112ab overlap at a certain angle of rotation. The above-described phase difference refers to this angle of rotation at which the two blades overlap.

As shown in FIG. 5, the second agitating-conveying member 113 includes: a helical auger screw including a helical second conveying blade (helical blade) 113a and a second rotational shaft 113b; and a second conveying gear 113c. The second agitating-conveying member 113 agitates and conveys the developer, by being rotationally driven by a driving means (not shown) such as a motor.

The second conveying blade 113a is a double helix blade having a double helix structure, and includes a second(A) helical blade 113aa and a second(B) helical blade 113ab.

The second(A) helical blade 113aa and the second(B) helical blade 113ab have identical helical pitches. In addition, a phase difference between the second(A) helical blade 113aa and the second (B) helical blade 113ab is 180 degrees.

A toner concentration detection sensor 119 is installed at a part which is approximately in the center in the developer conveyance direction and which is on the bottom surface of the developing tank 111 vertically below the second agitating-conveying member 113 (refer to FIG. 4). The toner concentration detection sensor 119 is installed such that the surface of the sensor is exposed inside the developing tank 111. The toner concentration detection sensor 119 is electrically connected to a toner concentration control means which is not shown. Depending on a toner concentration measurement value detected by the toner concentration detection sensor 119, the toner concentration control means controls and rotationally drives the toner-discharging member 122 to supply the toner to the inside of the developing tank 111 via the toner outlet 123, as shown in FIG. 3.

If it is determined that the toner concentration measurement value detected by the toner concentration detection sensor 119 is lower than a toner concentration setting value, a control signal is transmitted to the driving means that rotationally drives the toner-discharging member 122, and the toner-discharging member 122 is rotationally driven. A general toner concentration detection sensor including, for example, a transmitted-light detection sensor, a reflected light detection sensor, a magnetic-permeability detection sensor, and the like can be used as the toner concentration detection sensor 119. In the present embodiment, a magnetic-permeability detection sensor is used.

A power supply (not shown) is connected to the magnetic-permeability detection sensor. The power supply applies, on the magnetic-permeability detection sensor, a driving voltage to drive the magnetic-permeability detection sensor, and a control voltage in order to output a detection result of the toner concentration to the control means. The application of voltage on the magnetic-permeability detection sensor by the power supply is controlled by the control means. The magnetic-permeability detection sensor is a type of sensor that outputs the detection result of the toner concentration as an output voltage value when a control voltage is applied. Since the magnetic-permeability detection sensor basically has a fine sensitivity around a median of the output voltage, a control voltage that allows obtaining of an output voltage in the vicinity of the median is applied to the magnetic-permeability detection sensor. Such type of magnetic-permeability detection sensors are commercially available, including, for example, TS-L, TS-A, TS-K (all of which are product names and are manufactured by TDK Corp.), and the like.

As shown in FIG. 4, the developing tank covering 115, which is removable, is installed on the upper side of the developing tank 111. Furthermore, the toner supply opening 115a is formed on the developing tank covering 115, in order to supply the new toner to the inside of the developing tank 111.

Thus, as shown in FIG. 1, the toner contained in the toner-supplying device 22 is supplied to the developing tank 111, by having the toner transported to the inside of the developing tank 111 via the toner-conveying pipe 102 and the toner supply opening 115a.

As shown in FIG. 4 and FIG. 5, in the developing tank 111, the partition plate 117 is interposed between the first agitating-conveying member 112 and the second agitating-conveying member 113. The partition plate 117 is installed such that it extends parallel to the first agitating-conveying member 112 and the second agitating-conveying member 113 in both shaft directions (both rotational shaft directions). The inside of the developing tank 111 is partitioned by the partition plate 117 into a first conveying path P in which the first agitating-conveying member 112 is disposed, and a second conveying path Q in which the second agitating-conveying member 113 is disposed.

There is a distance between the partition plate 117 and the internal wall surface of the developing tank 111, at both ends, in respective shaft directions of the first agitating-conveying member 112 and the second agitating-conveying member 113. As a result, communicating paths that communicatively connect the first conveying path P and the second conveying path Q are formed in the developing tank 111 at the vicinity of both ends of the first agitating-conveying member 112 and the second agitating-conveying member 113 in both of the shaft directions. Hereinafter, as shown in FIG. 5, a communicating path formed on the arrow X direction side is referred to as a first communicating path a, and a communicating path formed on the arrow Y direction side is referred to as a second communicating path b.

The first agitating-conveying member 112 and the second agitating-conveying member 113 are arranged such that: circumferential surfaces of both agitating-conveying members face each other having the partition plate 117 in between; and the shafts of both agitating-conveying members are parallel to each other. Furthermore, both agitating-conveying members are configured such that each of the agitating-conveying members rotates in a direction opposite of the other. As shown in FIG. 5, the first agitating-conveying member 112 is configured so as to convey the developer in the arrow X direction, and the second agitating-conveying member 113 is configured so as to convey the developer in the arrow Y direction which is opposite of the arrow X direction.

The toner supply opening 115a is formed along the first conveying path P, and at a position toward the arrow X direction side from the second communicating path b. Thus, in the first conveying path P, the toner is supplied at the downstream side of the second communicating path b.

In the developing tank 111, the first agitating-conveying member 112 and the second agitating-conveying member 113 are rotationally driven by a driving means (not shown) such as a motor to convey the developer.

More specifically, the developer is conveyed to the arrow X direction along the first conveying path P while being agitated by the first agitating-conveying member 112, and reaches the first communicating path a. The developer that has reached the first communicating path a passes through the first communicating path a, and is conveyed to the second conveying path Q.

On the other hand, the developer is conveyed to the arrow Y direction along the second conveying path Q while being agitated by the second agitating-conveying member 113, and reaches the second communicating path b. Then, the developer that has reached the second communicating path b passes through the second communicating path b, and is conveyed to the first conveying path P.

Thus, the first agitating-conveying member 112 and the second agitating-conveying member 113 convey the developer in directions that are opposite to each other while agitating the developer.

In the manner described above, the developer circulates within the developing tank 111 along the first conveying path P, the first communicating path a, the second conveying path Q, and the second communicating path b, in a sequence of the first conveying path P→the first communicating path a→the second conveying path Q→the second communicating path b. As the developer is conveyed along the second conveying path Q, the developing roller 114 rotates to hold and pump up the developer on the surface of the developing roller 114. Then, the toner in the developer that has been pumped up moves to the photoconductor drum 3, resulting in a progressive consumption of the toner.

In order to supplement the consumed toner, a new toner is supplied to the first conveying path P from the toner supply opening 115a. The supplied toner is mixed and agitated with the developer that pre-exists in the first conveying path P.

### Sheet-Conveying Path

As shown in FIG. 1, the sheet-conveying path S is provided to the image forming apparatus 100 in order to guide a sheet from the paper feed tray 10 and a sheet from a manual feed tray 20, to the paper output tray 15 via the transfer part and the fusing device 12. The transfer part is located between the intermediate transfer belt driving roller 71 and the transfer roller 11.

In addition, pickup rollers 16a and 16b, a resist roller 14, the transfer part, the fusing device 12, conveying rollers 25a to 25f, and the like are disposed along the sheet-conveying path S.

The conveying rollers 25a to 25f are multiple small rollers that facilitate and assist conveying of the sheets, and are installed along the sheet-conveying path S. The pickup roller 16a is installed at one end of the paper feed tray 10, and is a pull-in roller that feeds the sheet-conveying path S with a sheet from the paper feed tray 10, one sheet at a time. The pickup roller 16b is installed in proximity to the manual feed tray 20, and is a pull-in roller that feeds the sheet-conveying path S with a sheet from the manual feed tray 20, one sheet at a time. The resist roller 14 temporarily holds the sheet conveyed by the sheet-conveying path S, and conveys the sheet to the transfer part at a timing that allows a front end of the toner image on the intermediate transfer belt 7 and a front end of the sheet to be aligned with each other.

A sheet-conveying operation by the sheet-conveying path S will be described in the following.

As shown in FIG. 1 and as described above, the image forming apparatus 100 includes: the paper feed tray 10 for storing the sheets in advance; and the manual feed tray 20 used in cases such as when printing a small number of sheets, and the two trays respectively include pickup rollers 16a and 16b in order to allow a sheet to be fed to the sheet-conveying path S by the pickup rollers 16a and 16b, one sheet at a time.

The sheet conveyed from the paper feed tray 10 is conveyed to the resist roller 14 by the conveying roller 25a along the sheet-conveying path S, and is conveyed to the transfer part (the contact position between the transfer roller 11 and the intermediate transfer belt 7) by the resist roller 14 at the timing that allows the front end of the sheet and the front end of the layered toner image on the intermediate transfer belt 7 to be aligned with each other. The toner image is transferred on the sheet at the transfer part, and the toner image is fused on the sheet by the fusing device 12. Then, the sheet is outputted onto the paper output tray 15 via the conveying roller 25b and the paper outputting roller 25c.

Furthermore, the sheet conveyed from the manual feed tray 20 is conveyed to the resist roller 14 by a plurality of conveying rollers 25 (25f, 25e, and 25d). The rest of the sheet-conveying operation goes through the same process as that of the sheet fed from the paper feed tray 10, and the sheet is outputted to the paper output tray 15.

### Alternate Example

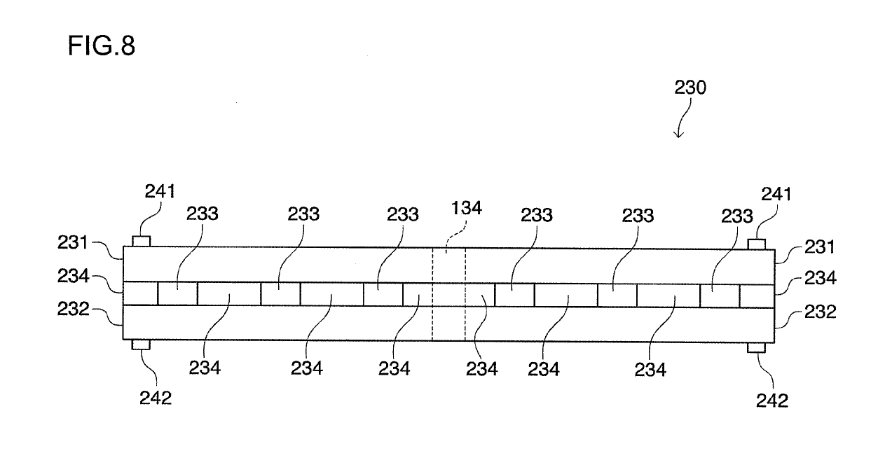

FIG. 8 is a cross sectional view, showing a partition wall 230 as an alternate example of the previously described partition wall 30 (FIG. 7). The partition wall 230 is a plate-like sandwich structure member including: six Peltier elements 233; a warming heat storage member 231 disposed on the fusing device housing part 100A side of the Peltier elements 233; and a cooling heat storage member 232 disposed on the developing device housing part 100B side of the Peltier elements 233. The six Peltier elements 233 and seven heat insulators 234 are alternately arranged. Due to an influence of the heat insulators 234, the effect of blocking heat conduction from the fusing device 12 to the developing device 2 after termination of the current supplied to the Peltier elements 233 can be enhanced.

The Peltier elements 233 are connected to a power supply (not shown) by electrical wiring, and current is passed through the Peltier elements 233 in a direction that allows the Peltier elements 233 to heat the warming heat storage member 231 and to cool the cooling heat storage member 232. As a result of heat being transferred from the developing device side to the fusing device side by the Peltier elements 233, applying and retaining heat to the fusing device 12, and cooling and reserving coldness for the developing device 2 can be conducted efficiently.

Two warming heat storage member temperature sensors 241 are disposed on a surface of the warming heat storage member 231 to detect the temperature of the warming heat storage member 231. Furthermore, two cooling heat storage member temperature sensors 242 are disposed on a surface of the cooling heat storage member 232 to detect the temperature of the cooling heat storage member 232. Excessive heating and cooling can be prevented by monitoring the temperatures of the warming heat storage member 231 and the cooling heat storage member 232, and by controlling an amount of current supplied to the Peltier elements 233.

The warming heat storage member 231 is a hollow thin box-shaped container which contains a low melting point material having a melting point of 60° C. or higher but 100° C. or lower; and the box-shaped container is made of a copper plate, an aluminum plate, a copper alloy plate or an aluminum alloy plate. The cooling heat storage member 232 is a hollow plate-like container containing a low melting point material having a melting point of 35° C. or higher but 45° C. or lower; and the plate-like container is made of a copper plate, an aluminum plate, a copper alloy plate or an aluminum alloy plate. Each of the containers has the previously described flexible structure which is expandable (or contractible) toward the opposite side (outwards) of the Peltier elements 233, and the structure can absorb an internal pressure caused when the low melting point material expands (or contracts). A styrene foam or the like can be used as the heat insulators 234.

A slit 134 is formed on the partition wall 230 in order to allow a sheet to pass through the partition wall 230 from the developing device housing part 100B to the fusing device housing part 100A.

The warming heat storage member 231, which is heated by the Peltier elements 233, is preferably controlled at a temperature higher than the melting point of the low melting point material, such that the contained low melting point material (melting point of 60° C. or higher but 100° C. or lower) is in a melted state (i.e., a state in which solidification energy is stored therein). However, since energy loss becomes significant if the control temperature is too high, the control temperature is preferably about 1° C. to 10° C. higher than the melting point.

The cooling heat storage member 232, which is cooled by the Peltier elements 233, is preferably controlled at a temperature lower than the melting point of the low melting point material, such that the contained low melting point material (melting point of 35° C. or higher but 45° C. or lower) is in a solidified state (i.e., a state that can absorb melting energy). However, since energy loss becomes significant if the control temperature is too low, the control temperature is preferably about 1° C. to 10° C. lower than the melting point.

What is claimed is:

1. An image forming apparatus comprises: a fusing device; a developing device; a partition wall disposed between the fusing device and the developing device, wherein the partition wall includes a Peltier element for transferring heat from the developing device to the fusing device and a cooling heat storage member disposed nearer to the developing device than the Peltier element.

2. The image forming apparatus of claim 1, wherein the partition wall includes a warming heat storage member disposed nearer to the fusing device than the Peltier element.

3. The image forming apparatus of claim 1, wherein the cooling heat storage member includes a first material having a low melting point higher than ordinary temperature.

4. The image forming apparatus of claim 3, wherein the first material has a melting point of 35° C. or higher but 45° C. or lower.

5. The image forming apparatus of claim 2, wherein the warming heat storage member includes a second material having a melting point higher than the first material but of 100° C. or lower.

6. The image forming apparatus of claim 5, wherein the second material has a melting point of 60° C. or higher but 100° C. or lower.

7. The image forming apparatus of claim 3, wherein the first material is contained in a container made of a copper plate, an aluminum plate, a copper alloy plate or an aluminum alloy plate, the container having a structure of which volume is variable.

8. The image forming apparatus of claim 5, wherein the second material is contained in a container made of a copper plate, an aluminum plate, a copper alloy plate or an aluminum alloy plate, the container having a structure of which volume is variable.

9. The image forming apparatus of claim 2 further comprising a first and a second temperature sensors which respectively detect temperatures of the cooling heat storage member and the warming heat storage member, respectively, wherein the Peltier element is controlled based on the temperatures detected by the first and the second temperature sensors.

10. The image forming apparatus of claim 2, wherein the Peltier element is interposed between the cooling heat storage member and the warming heat storage member.

11. The image forming apparatus of claim 10, wherein the Peltier element is controlled so as to heat the warming heat storage member and cool the cooling heat storage member.

12. The image forming apparatus of claim 10 further comprising a heat insulator interposed between the cooling heat storage member and the warming heat storage member.

13. The image forming apparatus of claim 3, wherein the first material is an organic material selected from ester compounds, alcohols, aliphatic compounds, nitrogen-containing aromatic compounds, phenol compounds and siloxane compounds.

14. The image forming apparatus of claim 3, wherein the first material is selected from 1-tetradecanol, myristyl alcohol, dodecyl palmitate and methyl arachidate.

15. The image forming apparatus of claim 5, wherein the second material is an organic material selected from alcohols, fatty acids, ester compounds, hydroxyl-fatty acids, fatty amids and ketone compounds.

16. The image forming apparatus of claim 5, wherein the second material is selected from Rose's alloy, Newton's alloy, Wood's alloy and Lipowitz's alloy.
